(19) United States
(12) Patent Application Publication
(10) Pub. No.: US 2010/0282173 A1
(43) Pub. Date: Nov. 11, 2010

(54) METHOD AND DEVICE FOR CONTROLLING THE MILKING BY A MILKING MACHINE

(75) Inventors: Torbjorn Petterson, Gnesta (SE); Ola Sandberg, Gnesta (SE); Eva Pia Sandstedt, Gnesta (SE)

Correspondence Address: YOUNG & THOMPSON, 209 Madison Street, Suite 500, Alexandria, VA, 22314, US

(73) Assignee: DELAVAL HOLDING AB, Tumba (SE)

(21) Appl. No.: 12/811,434

(22) PCT Filed: Dec. 30, 2008
(86) PCT No.: PCT/SE08/51569

§ 371 Date: Jul. 1, 2010

(30) Foreign Application Priority Data
Jan. 2, 2008 (SE) 0800005-1

(51) Int. Cl. A01J 5/007

(52) U.S. Cl. 119/14.02; 119/14.08

(57) ABSTRACT

A method for controlling the milking by a milking machine, which milking machine includes a plurality of teat cups (19), each teat cup having a flexible teat receiving liner (33) arranged inside a rigid teat cup shell (35), wherein, during milking, a working vacuum is applied to the interior of the teat receiving liner of each teat cup to draw milk from a respective teat (37) of a milking animal while the teat receiving liner of the respective teat cup is periodically opened and collapsed by application of a pulsating vacuum between the teat receiving liner and the teat cup shell, and according to the method, a flow level of milk drawn from the milking animal is measured and, if the measured flow level is above a threshold, the pulsation ratio of the periodic opening and collapsing of the teat receiving liner of one or more of the teat cups is decreased for a following part of the milking or for a following milking of the milking animal.

### TECHNICAL FIELD OF THE INVENTION

The present invention relates generally to dairy farming and to milking of dairy animals therein. Particularly, the invention relates to a method and a device for controlling the milking by a milking machine.

### DESCRIPTION OF RELATED ART AND BACKGROUND OF THE INVENTION

In modern dairy farm industry there are continuous research and development activities in order to improve the efficiency of various activities such as machine milking, which, inter alia, involves increased milk yield and reduced milking time, while, naturally, ethical aspects as well as animal care are considered.

Machine milking, as known in the art, generally utilizes teat cups and vacuum sources to perform the milking function. In such systems each teat is contained within a teat cup having a teat receiving liner inside the teat cup next to the teat. A working vacuum is applied to the interior of each teat receiving liner to draw the milk from the teat, with the teat receiving liners periodically opened and collapsed by applications of a pulsating massage vacuum between the teat receiving liner and the inside of the cup. This periodic working of the teat receiving liners results in the periodic flow of milk from each teat into a receiving vessel, and constitutes the actual milking of the cow.

Typically the vacuum parameters used, e.g. working vacuum, high and low pulsating massage vacuum, pulsation ratio, and pulsation rate, are the same for all milking animals milked by a milking machine.

U.S. Pat. Nos. 4,011,838 and 5,054,425 and European Patents Nos. 0954962 B1, 0679331 B1, and 0403549 B1 disclose different milking systems for improving the milking. However, they fail to disclose how to obtain animal individual milking, which is optimized for each single milking animal.

### SUMMARY OF THE INVENTION

Some milking animals show an extremely high milk flow rate during milking, and have also a very short milking time. In batch wise milking particularly, there is no reason to milk such a milking animal so fast. Besides, a slower emptying of the udder of the milking animal may be milder to the milking animal.

Further, a high milk flow rate may lower the vacuum in the teat cups to an extent where the frequency of teat cup slips or even dropped teat cups is too high.

Yet further, some milking animals have a tendency of so-called second milk letdown, i.e. a drop in the milk flow rate when the cistern milked have been milked and before the milking of the alveoli milk begins running. This leads inevitably to creeping of teat cups up on the teats of the milking animal and prolongs the milking time. It may also be unpleasant, or even harmful, to the milking animal.

Still further, if a milking animal is to be dry, the udder of such milking animal is not emptied completely and the milking time is considerably shortened and a different procedure is obtained. Since a milking animal should be kept with habitual procedures, such milking may be unfavorable for the milking animal.

It is therefore an object of the present invention to provide a method and a device for controlling the milking by a milking machine, by which the above-mentioned problems and shortcomings can be alleviated, or at least reduced.

It is in this respect a particular object of the invention to provide such a method and such a device, by which the animal care and treatment are improved.

It is a further object of the invention to provide such a method and such a device, by which creeping of teat cups up on the teats is avoided and by which the milking times can be considerably shortened.

It is still a further object of the invention to provide such a method and such a device, by which the number of teat cup slips and drops can be reduced.

It is yet a further object of the invention to provide such a method and such a device, by which overall milk production can be increased.

It is a further object of the invention to provide such a method and such a device, which are accurate, precise, efficient, reliable, of reasonable cost, and easy to implement.

Methods and devices as defined in the appended patent claims attain these objects, among others.

According to a first aspect of the invention there is provided a method for controlling the milking by a milking machine, which comprises a plurality of teat cups, where each teat cup has a flexible teat receiving liner arranged inside a rigid teat cup shell. During milking, a working vacuum is applied to the interior of the flexible teat receiving liner of each teat cup to draw milk from a respective teat of a milking animal received therein while the flexible teat receiving liner of the respective teat cup is periodically opened and collapsed by application of a pulsating massage vacuum between the flexible teat receiving liner and the rigid teat cup shell. According to the inventive method a flow level of milk drawn from the milking animal is measured and, depending on the measured flow level, the pulsation ratio of the periodic opening and collapsing of the flexible teat receiving liner of one or more of the teat cups is changed for a following part of the milking or for a following milking of the milking animal.

Preferably, the pulsation ratio of the periodic opening and collapsing of the flexible teat receiving liner of the one or more of the teat cups is decreased for a following part of the milking or for a following milking of the milking animal provided that the measured flow level of milk drawn from the milking animal exceeds a threshold level.

By means of the present invention the animal care is improved. The number of teat cup slips and drops and the occurrence of milking animals with second milk letdown are alleviated or reduced.

Several embodiments of the invention illustrate different trigger mechanisms for when the pulsation ratio should be changed or decreased. Such triggers may comprise the milking time, the frequency of teat cup slips and/or teat cup drops, the occurrence of second milk let downs, and the knowledge that the milking animal is to be dry.

Further, not only the pulsation ratio may be changed, but any other milking parameters may be changed, e.g. by employing the same trigger mechanism. Such milking parameters include particularly the pulse rate and the phase shift between the periodic opening and collapsing of two of the flexible teat cup liners.

In some instances the pulsation ratio may even be increased. If for instance the measured flow level of milk drawn from a milking animal during batch wise milking, in particular, is very low it may cause the milking time for the batch of milking animals to be prolonged. In such instance, the pulsation ratio may be increased in order to increase the milk flow rate of that milking animal.

According to a second aspect of the invention there is provided a device for implementing the above method. The device comprises an input terminal connected to receive a flow level of milk drawn from the milking animal as measured by a flow meter of the milking machine, and a control unit for creating a control signal depending on the received flow level, wherein the control signal controls a pulsator of the milking machine to change the pulsation ratio of the periodic opening and collapsing of the flexible teat receiving liner of one or more of the teat cups for a following part of the milking or for a following milking of the milking animal. An output terminal is provided for enable the transmission of the control signal to the pulsator.

Advantageously, the above method and device can be implemented separately for each teat cup of the milking machine.

Further characteristics of the invention and advantages thereof, will be evident from the detailed description of embodiments of the present invention given hereinafter and the accompanying FIGS. 1-3, which are given by way of illustration only and thus, are not limitative of the present invention.

### BRIEF DESCRIPTION OF THE DRAWINGS

FIG. 1 illustrates schematically main components of a milking system, wherein an embodiment of the present invention is implemented.

FIG. 2 illustrates schematically, in a cross sectional view, a teat cup of the milking system of FIG. 1.

FIG. 3 is an example diagram of the pulsating vacuum level as a function of time during milking. The pulsation ratio and the pulsation rate are indicated.

### DETAILED DESCRIPTION OF EMBODIMENTS

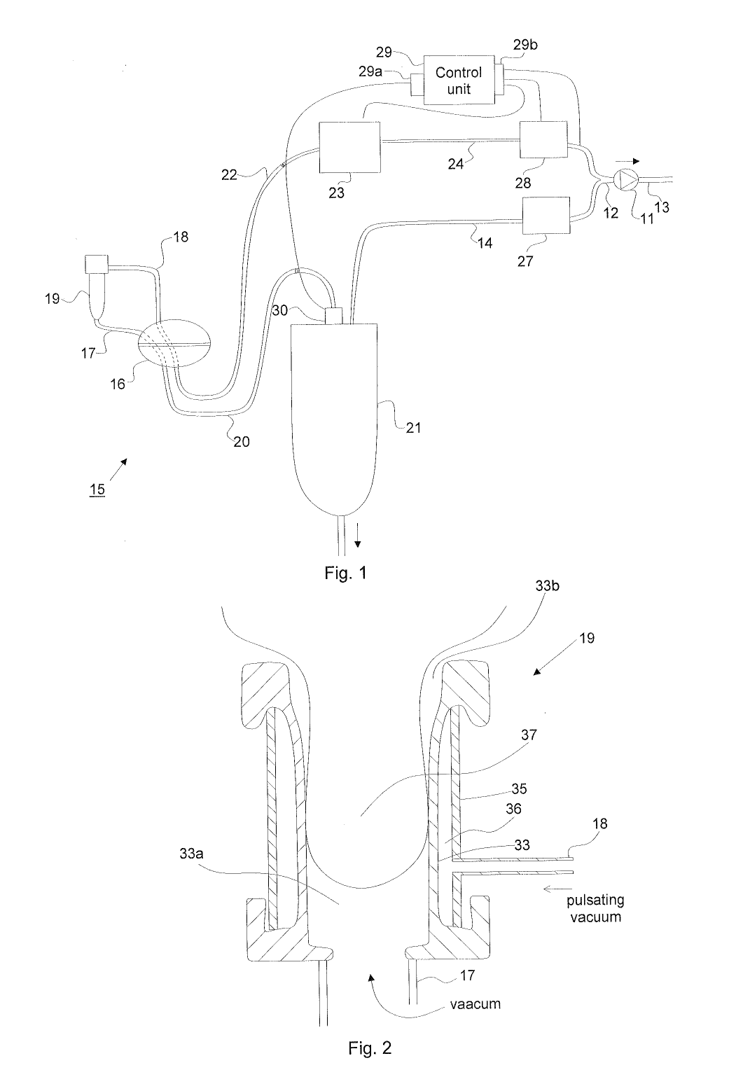

A milking system according to an embodiment of the invention is partly disclosed in FIG. 1. A vacuum pump 11 has a suction side 12 and a pressure side 13, wherein the suction side 12 of the vacuum pump 11 is via a vacuum conduit 14 connected to a milking device 15.

The milking device 15 comprises a milking claw 16, which, via a milk tube 17 and a pulse tube 18, is connected to a teat cup 19 provided to be attached to a teat of an animal, such as a cow, to be milked. Of course, the milking device 15 may comprise more than one milking claw and each milking claw may be connected to more than one teat cup. In case the animals are cows four teat cups are needed for the milking of each animal.

The teat cup 19, which is shown in greater detail in FIG. 2, has a flexible teat receiving liner 33 arranged inside a rigid teat cup shell 35. The flexible teat receiving liner 33 defines a teat receiving opening in an upper interior part 33b thereof for receiving a teat 37 of an animal to be milked. A lower interior part 33a of the flexible teat receiving liner 33 is connected to the milking claw 16 via the milk tube 17. The annular space 36 formed between the flexible teat receiving liner 33 and the rigid teat cup shell 35 is connected to the milking claw 16 via the pulse tube 18.

The milking device 15 further comprises a receiving vessel 21 which is connected to the milking claw 16 via a further milk tube 20. The receiving vessel 21, which is connected to the vacuum conduit 14, may be provided with a separator for intermittently removing separated liquid and for preventing that liquid is introduced in the vacuum conduit 14.

Furthermore, a pulsator 23 is connected to the milking claw 16 via a pulse tube 22. The pulsator 23 may be connected, as illustrated, to the vacuum pump 11 via a further vacuum conduit in order to be capable of controlling the pulsation and milking vacuum levels independently of each other. Alternatively, the pulsator 23 is connected to the vacuum conduit 14 and uses the same vacuum regulation as is used for the milk tube 17.

The vacuum pump 11 sucks a flow of air from the milking device 15 via the vacuum conduits 14 and 24. Hereby, a milking vacuum is produced in the lower interior part 33a of the teat receiving liner 33 of the teat cup 19 via the vacuum conduit 14, the receiving vessel 21, and the milk tubes 20 and 17. Similarly, a pulsating vacuum is produced in the annular space 36 between the teat receiving liner 33 and the teat cup shell 35 via the further vacuum conduit 24, the pulsator 23, and the pulse tubes 22 and 18. The pulsating vacuum varies during a pulsation cycle, for instance between atmospheric pressure and a maximum pulsating vacuum and causes the teat receiving liner 33 to periodically open and collapse to thereby massage the teat and stimulate milk ejection. By means of the applied milking and pulsating vacuums, milk is drawn from the teat of an animal to the receiving vessel 21.

A milk flow meter or other milk quantity measuring device 30 is provided e.g. at the inlet to the receiving vessel 21 to measure the flow or instantaneous quantity of milk produced during the milking.

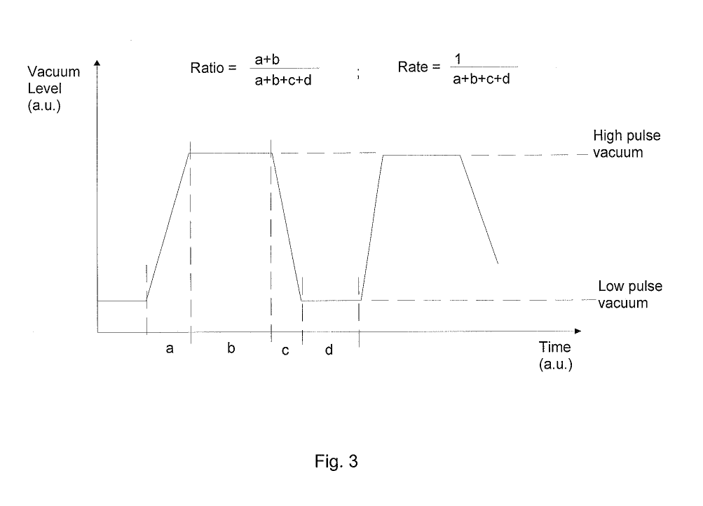

An example diagram of the pulsating vacuum level as a function of time during milking is illustrated in FIG. 3. For each pulsating cycle four phases can be identified: a pulse vacuum increasing phase a, a phase of high pulse vacuum b, a pulse vacuum decreasing phase c, and a phase of low pulse vacuum d. The high pulse vacuum may or may not be equal to the milking vacuum and the low pulse vacuum may or may not be equal to atmospheric pressure. The pulsating vacuum can be characterized by the pulsation ratio and the pulsation rate as indicated in FIG. 3. The pulsation ratio is equal to (a+b)/(a+b+c+d) and the pulsation rate is equal to 1/(a+b+c+d).

A control unit 29 is provided for controlling the vacuum levels in the vacuum conduits 14 and 24 via valve arrangements or vacuum regulators 27 and 28. The vacuum regulators may each be any kind of regulator that regulates or controls the vacuum in the respective conduits. Further, the control unit 29 is provided for controlling the pulsation ratio and optionally the pulsation rate. An output terminal arrangement 29b of the control unit 29 is connected to the pulsator 23 and to vacuum regulators 27 and via respective control signal connections for transferring control signals to the pulsator 23 and to vacuum regulators 27 and 28.

It shall be appreciated that the control unit 29 may be provided for controlling the pulsator 23 only. In such instance separate control device(s) may be provided for controlling the vacuum regulators 27 and 28. For instance, the vacuum regulators 27 and 28 may be simple self regulating mechanical vacuum regulators.

Further, the milk flow meter or the other milk quantity measuring device 30 is connected to an input terminal 29a of the control unit 29 via a signal connection so that the control unit 29 may receive the measured flow or instantaneous quantity of milk drawn from the animal during milking.

In accordance with the present invention the control unit 29 creates a control signal depending on a measured flow as received from the milk flow meter 30, wherein the control signal controls the pulsator 23 to change the pulsation ratio of the periodic opening and collapsing of the flexible teat receiving liner 33 of the teat cup 19 for a following part of the milking or for a following milking of the animal.

The control unit 29 may create a control signal that is used to control the pulsation rate of the periodic opening and collapsing of the flexible teat receiving liner 33 of one or more teat cups simultaneously. Further, the measurements of the flow and the control of the pulsation ratio of the periodic opening and collapsing of the flexible teat receiving liner(s) may be performed repeatedly during the milking of the animal.

By means of the present invention the animal care can be improved. The emptying of the udders of the animals can be made milder to the animal. The number of teat cup slips and drops and the occurrence of milking animals with second milk letdown can be alleviated or reduced. Hereby, also the milking production will be improved.

Several embodiments of the invention illustrate different trigger mechanisms for when the pulsation ratio should be changed, i.e. decreased or even increased. In other embodiments not only the pulsation ratio may be changed, but also any other milking parameters may be changed.

In one embodiment the measured flow received from the milk flow meter 30 is a flow of milk drawn from all the teats of the milked animal. The control unit 29 then creates a control signal depending on the measured flow of milk drawn from all the teats of the milked animal, wherein the control signal controls the pulsator 23 to change the pulsation ratio of the periodic opening and collapsing of the flexible teat receiving liners 33 of all the teat cups of the milking device 15 for a following part of the milking or for a following milking of the animal.

In another embodiment the control unit 29 creates a control signal that causes the pulsator 23 to decrease the pulsation ratio of the periodic opening and collapsing of the flexible teat receiving liner of one or more teat cups for a following part of the milking or for a following milking of the animal if the measured flow of milk drawn from the animal exceeds a threshold level.

In still another embodiment a device is provided for measuring the milking time for the milking of the animal and for forwarding this measure to the control unit 29.

Depending on the measured milking time, the control unit 29 creates a control signal that causes the pulsator 23 to change the pulsation ratio of the periodic opening and collapsing of the flexible teat receiving liner of one or more teat cups for a following milking of the animal. Particularly, the pulsation ratio is decreased for the following milking of the animal provided that the measured milking time is lower than a threshold level.

In yet another embodiment a device is provided for measuring a vacuum level in the milking machine or for measuring the frequency of teat cup slips and/or teat cup drops during the milking of the animal and for forwarding such measure to the control unit 29.

Depending on the measured vacuum level in the milking machine or the frequency of teat cup slips and/or teat cup drops, the control unit 29 creates a control signal that causes the pulsator 23 to change the pulsation ratio of the periodic opening and collapsing of the flexible teat receiving liner of one or more teat cups for a following part of the milking or for a following milking of the animal. Particularly, the pulsation ratio is decreased provided that the measured vacuum level in the milking machine is lower than a threshold level or that the frequency of the teat cup slips and/or teat cup drops exceeds a threshold level.

In still another embodiment a device for detecting occurrence of a second milk let down during the milking of the animal and for forwarding such detection to the control unit 29.

If a second milk let down is detected, the control unit 29 creates a control signal that causes the pulsator 23 to change the pulsation ratio of the periodic opening and collapsing of the flexible teat receiving liner of one or more teat cups for a following part of the milking or for a following milking of the animal. Particularly, the pulsation ratio is decreased in this scenario.

In yet another embodiment the control unit 29 creates a control signal that causes the pulsator 23 to increase the pulsation ratio of the periodic opening and collapsing of the flexible teat receiving liner of the one or more teat cups for a following part of the milking or for a following milking of the animal e.g. provided that the measured flow of milk drawn from the animal is lower than a threshold level.

Further, the pulsation ratio may be changed, e.g. decreased or increased, for following milkings of the animal provided that the animal is to be dry.

In still another embodiment the control unit 29 creates a control signal that causes the pulsator 23 to change the pulsation rate of the periodic opening and collapsing of the flexible teat receiving liner of one or more teat cups for the following part of the milking or for the following milking of the animal depending on the measured flow. The pulsation rate may be increased or decreased depending on whether the pulsation rate change should increase or decrease the milk flow.

In yet another embodiment the control unit 29 creates a control signal that causes the pulsator 23 to change a phase shift between the periodic opening and collapsing of two of the flexible teat cup liners depending on the measured flow.

It may under some circumstances be appropriate to change the pulsation rate and/or the phase shift when the pulsation ratio is altered depending on the equipment used. For instance, it is important to keep as stable vacuum levels as possible in the milking system at all times.

It shall be appreciated that the milking system in which the present invention can be used encompasses robotized, semi-automated, as well as manual milking systems. Further, the invention may be employed in milking systems wherein the milking vacuum and/or the pulsating vacuum is controlled on a teat cup individual basis. In such instance the milk flow from each teat is also measured separately.

It shall further be appreciated that the various variants and embodiments as described in the present text may be combined in any arbitrary manner to reach yet further embodiments of the invention.

1. A method for controlling the milking by a milking machine, which milking machine comprises a plurality of teat cups (19), each teat cup having a flexible teat receiving liner (33) arranged inside a rigid teat cup shell (35), wherein, during milking, a working vacuum is applied to the interior of the flexible teat receiving liner of each teat cup to draw milk from a respective teat (37) of a milking animal received therein while the flexible teat receiving liner of the respective teat cup is periodically opened and collapsed by application of a pulsating massage vacuum between the flexible teat receiving liner and the rigid teat cup shell, said method comprising the steps of:
measuring a flow level of milk drawn from the milking animal; and
changing the pulsation ratio of said periodic opening and collapsing of the flexible teat receiving liner of one or more of the teat cups in dependence on said measured flow level, wherein when the measured flow level of milk drawn from the milking animal exceeds a threshold level, the pulsation ratio of said periodic opening and collapsing of the flexible teat receiving liner of said one or more of the teat cups is decreased for at least one of i) a following part of the milking and ii) for a following milking of the milking animal.

2. The method of claim 1 wherein the measured flow level of milk drawn from the milking animal is a flow level of milk drawn from all the teats of the milking animal and, depending on the measured flow level of milk drawn from all the teats of the milking animal, the pulsation ratio of said periodic opening and collapsing of the flexible teat receiving liner of all the teat cups is changed for a following part of the milking or for a following milking of the milking animal.

3. The method of claim 1 wherein the measured flow level of milk drawn from the milking animal is a flow level of milk drawn from one of the teats of the milking animal via one of the teat cups and, depending on the measured flow level of milk drawn from said one teat of the milking animal, the pulsation ratio of said periodic opening and collapsing of the flexible teat receiving liner of said one teat cup is changed for a following part of the milking or for a following milking of the milking animal.

4. The method of claim 1 wherein said flow level of milk drawn from the milking animal is measured repeatedly during said milking and, depending on the repeatedly measured flow level, the pulsation ratio of said periodic opening and collapsing of the flexible teat receiving liner of said one or more of the teat cups is changed repeatedly during the milking of the milking animal.

5. The method of claim 1 wherein the milking time is measured for the milking of the milking animal and, depending on the measured milking time, the pulsation ratio of said periodic opening and collapsing of the flexible teat receiving liner of said one or more of the teat cups is changed for a following milking of the milking animal.

6. The method of claim 5 wherein the pulsation ratio of said periodic opening and collapsing of the flexible teat receiving liner of said one or more of the teat cups is decreased for a following milking of the milking animal provided that the measured milking time is lower than a threshold level.

7. The method of claim 1, comprising the further steps of:
during the milking of the milking animal, measuring at least one of i) a vacuum level in said milking machine, ii) a frequency of teat cup slips, and iii) a frequency of teat cup drops; and
depending on a result of said measuring during the milking step, changing the pulsation ratio of said periodic opening and collapsing of the flexible teat receiving liner of said one or more of the teat cups for a following part of the milking or for a following milking of the milking animal.

8. The method of claim 7 wherein the pulsation ratio of said periodic opening and collapsing of the flexible teat receiving liner of said one or more of the teat cups is decreased for a following part of the milking or for a following milking of the milking animal provided that the measured vacuum level in said milking machine is lower than a threshold level or that the frequency of the teat cup slips and/or teat cup drops exceeds a threshold level.

9. The method of claim 1, comprising the further steps of:
monitoring for an occurrence of a second milk let down during the milking of the milking animal; and
when a second milk let down is detected by the monitoring, decreasing the pulsation ratio of said periodic opening and collapsing of the flexible teat receiving liner of said one or more of the teat cups for a following part of the milking or for a following milking of the milking animal.

10-11. (canceled)

12. The method of claim 1 wherein, depending on the measured flow level, a phase shift between the periodic opening and collapsing of two of the flexible teat cup liners is changed.

13. A device for controlling the milking by a milking machine, which comprises a plurality of teat cups (19), each teat cup having a flexible teat receiving liner (33) arranged inside a rigid teat cup shell (35), wherein, during milking, a working vacuum is applied to the interior of the flexible teat receiving liner of each teat cup to draw milk from a respective teat (37) of a milking animal received therein while the flexible teat receiving liner of the respective teat cup is periodically opened and collapsed by application of a pulsating massage vacuum between the flexible teat receiving liner and the rigid teat cup shell, said control device comprising:
an input terminal (29a) connected for receiving a flow level of milk drawn from the milking animal as measured by a flow meter of said milking machine;
a control unit (29) for creating a control signal depending on the received flow level, said control signal controlling a pulsator of said milking machine to change the pulsation ratio of said periodic opening and collapsing of the flexible teat receiving liner of one or more of the teat cups; and
an output terminal (29b) connected for transferring said control signal to said pulsator, wherein when the measured flow level of milk drawn from the milking animal exceeds a threshold level, said control unit (29) is adapted to create a control signal controlling said pulsator to decrease the pulsation ratio of said periodic opening and collapsing of the flexible teat receiving liner of said one or more of the teat cups for at least one of i) a following part of the milking and ii) a following milking of the milking animal.

14. A method for controlling the milking by a milking machine, which milking machine comprises a plurality of teat cups (19), each teat cup having a flexible teat receiving liner (33) arranged inside a rigid teat cup shell (35), wherein, during milking, a working vacuum is applied to the interior of the flexible teat receiving liner of each teat cup to draw milk from a respective teat (37) of a milking animal received therein while the flexible teat receiving liner of the respective teat cup is periodically opened and collapsed by application of a pulsating massage vacuum between the flexible teat receiving liner and the rigid teat cup shell, said method comprising the steps of:
measuring a flow level of milk drawn from the milking animal; and
changing the pulsation ratio of said periodic opening and collapsing of the flexible teat receiving liner of one or more of the teat cups in dependence on said measured flow level such that
during a first time period wherein when the measured flow level of milk drawn from the milking animal exceeds a threshold level, the pulsation ratio of said periodic opening and collapsing of the flexible teat receiving liner of said one or more of the teat cups is decreased for a first following part of the milking, and
during a second time period wherein when the measured flow level of milk drawn from the milking animal is lower than a threshold level, the pulsation ratio of said periodic opening and collapsing of the flexible teat receiving liner of said one or more of the teat cups is increased for a second following part of the milking.

15. A device for controlling the milking by a milking machine in accordance with claim 14, the device comprises comprising:
an input terminal (29a) connected for receiving a flow level of milk drawn from the milking animal as measured by a flow meter of said milking machine;
a control unit (29) for creating a control signal depending on the received flow level, said control signal controlling a pulsator of said milking machine to change the pulsation ratio of said periodic opening and collapsing of the flexible teat receiving liner of one or more of the teat cups; and
an output terminal (29b) connected for transferring said control signal to said pulsator,
wherein said control unit (29) is adapted to create a control signal controlling said pulsator dependent on how the measured flow level of milk drawn from the milking animal compares to the threshold level.
